(19) United States
(12) Patent Application Publication
(10) Pub. No.: US 2022/0270504 A1
(43) Pub. Date: Aug. 25, 2022

(54) ONLINE EDUCATION SYSTEM

(71) Applicants: Tony Hu, Oakland, CA (US); Chang Ma, Oakland, CA (US); Xibin Gong, Oakland, CA (US); Yison Gu, Oakland, CA (US)

(72) Inventors: Tony Hu, Oakland, CA (US); Chang Ma, Oakland, CA (US); Xibin Gong, Oakland, CA (US); Yison Gu, Oakland, CA (US)

(73) Assignee: Patten University, Oakland, CA (US)

(21) Appl. No.: 17/180,344

(22) Filed: Feb. 19, 2021

(51) Int. Cl. G09B 5/12; G06N 20/00; G06Q 50/20; G06F 16/28; H04L 29/08; G09B 5/06

(52) U.S. Cl. CPC G09B 5/12; G06N 20/00; G06Q 50/2053; G06F 16/283; H04L 67/1002; H04L 67/2895; G09B 5/065

(57) ABSTRACT

An online educational system includes a load balancing reverse proxy server adapted to receive requests from a plurality of student clients and institution clients; a platform coupled to the server, the platform comprising supporting services including tuition and fee payment management, identity and role management, student application status management services; an analytical data warehouse and databases coupled to the platform; a data warehouse coupled to the analytical data warehouse; and a machine learning network coupled to the data warehouse to generate educational recommendations to help students learn.

### FIELD OF THE INVENTION

The present invention relates to an on-line educational system.

### BACKGROUND OF THE INVENTION

Higher education providers are becoming increasingly aware of the diversity of their current and potential learners and are moving to provide a range of options for their engagement. The Internet is offering increasingly flexible delivery modes to students in providing multiple pathways and opportunities for those seeking further education. However, n changing between and across regular and on-line learning modes, a one-size-fits-all approach is often used. While educational materials are routinely distributed to users in conjunction with videoconferencing systems for teaching an educational course on-line, more thoughtful features are needed in order to successfully execute the course and gain the full benefits of on-line education over in-classroom teaching.

### SUMMARY

In one aspect, an online educational system includes a load balancing reverse proxy server adapted to receive requests from a plurality of student clients and institution clients; a platform coupled to the server, the platform comprising supporting services including tuition and fee payment management, identity and role management, student application status management services; an analytical data warehouse and databases coupled to the platform; a data warehouse coupled to the analytical data warehouse; and a machine learning network coupled to the data warehouse to generate educational recommendations to help students learn.

In another aspect, an all in one solution for online education platform includes: a student client to access course content, an instructor/author client to create online courses, a payment service to handle tuition and fee payment, a monitoring module to keep up system running and send alert for abnormal or predetermined learning behavior(s), a module to keep track of student enrollment and learning status, and a data analysis service to enhance student learning experience on the platform.

In a further aspect, a method to manage students from application to graduation including receiving courseware from a plurality of educational institutions, wherein the courseware includes one or more videos generated by an instructor, further comprising translating and captioning the video for global student use; receiving student work experience and educational history and crediting the student with predetermined credits toward a graduation requirement from a selected institution; determining courses need for graduation and learning from online course materials as specified by the selected institution; and upon completion of the graduation requirement, storing a digital diploma from the selected institution for student use as proof of graduation.

Advantages of the system may include one or more of the following. With the online programs, the system helps students acquire the skills and knowledge needed to advance his/her education and career. The flexible online learning platform enables freedom to earn a degree on the student's terms while still enjoying close interaction with faculty, advisors and other students in an engaging learning environment. Education is made affordable so that students can earn a degree without acquiring a burden of debt. The innovative tuition model and strategic reduction of bureaucratic overhead allows the system to lower costs and pass the savings to students. The system offers a degree program that matches with student interests and goals. The system helps students earn a degree to open a successful career, where the length of studying depends on how much knowledge the student already possesses and focuses on missing areas required for graduation. The classes are taught from on-line classrooms, but they also include study guides. This is very helpful for those who do not have all the time in the world to sit in the classroom learning all the information needed to learn about a specific subject. The online university provides the opportunity to study whenever it fits a student schedule, the ability to review assignments and read textbooks at the student's own pace, and the ability to take care of the course work at his/her own pace.

The system more people getting on-line and earning degrees every year. More people are looking for ways that they can earn an on-line degree because it gives them more options for their career. The system complies with the school's accreditation. This means that the institution has been officially accredited by the Commission on International and Trans-Regional Accreditation of Education (CITRA) in order to operate on the Internet. The commission does this to ensure that accredited institutions are legitimate.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 shows an exemplary online education platform.

FIG. 2 shows an exemplary flow of the system of FIG. 1 connecting students/users with institutions.

FIG. 3 shows an exemplary flow of student services provided by the LINQ system.

FIG. 4 shows an exemplary process for educating students.

FIG. 5A shows in more details an exemplary application process for applicants.

FIG. 5B shows an exemplary architecture for deployment and infrastructure.

FIG. 6A-6K shows exemplary student user interface designs for the platform.

FIGS. 7A-7I show an exemplary process for generating educational materials and their use with to achieve personal growth objectives.

FIGS. 8A-8B show an exemplary AI enabled educational platform.

FIGS. 8C-8F show exemplary AI-based student profilers.

### DETAILED DESCRIPTION

An exemplary educational system called LINQ is detailed below. LINQ is a data-driven, AI (Artificial intelligence) powered online learning platform. AI is used to address two fundamental questions of education industry: what is taught and how it is taught. The system includes an OEP (Online Educational Platform) which the data source role of the whole system and is the core piece. It is a new all-in-one LMS (Learning Management System) built on Instructure Canvas open source codebase. OEP uses Ruby on Rails as the web app framework, H5 & CSS3 as frontend UI and PostreSQL as backend database.

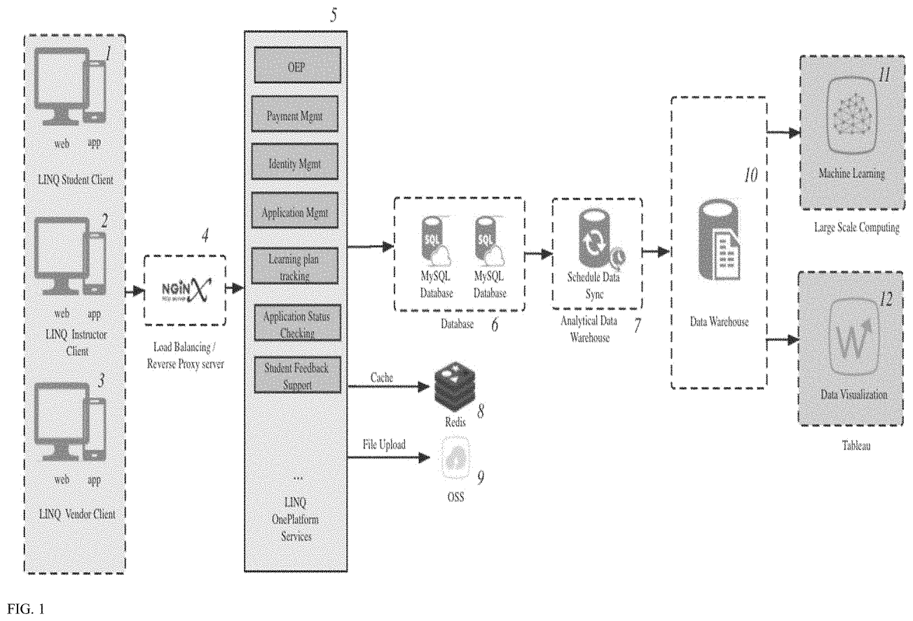

FIG. 1 shows an exemplary online education platform that includes student client 101 that allows student access to multimedia course content. Cross platform apps can be accessible through PC web browser or LINQ student mobile app. The client can be a third-party client 102 such as a 3rd party organization, colleges or other institutions and/or individual instructors using LINQ platform. The client 102 provides 3rd party access to processed student application status, learning plan and history tracking info and feedback. The system also communicates with a vendor client 103, for example a client for a vendor to manage student resources. The clients 101-103 communicate with load balancing/reverse proxy servers 104. One embodiment uses an NGINX server that provides load balancing and reverse proxy between clients and the server 104. Nginx, stylized as NGINX or nginx or NginX, is a web server that can also be used as a reverse proxy, load balancer, mail proxy and HTTP cache. The server performs the following:

HTTP Load Balancing

TCP and UDP Load Balancing

HTTP Health Checks

TCP Health Checks

UDP Health Checks

Dynamic Configuration of Upstreams with the NGINX Plus API

Accepting the PROXY Protocol

The server 104 communicates with an educational service called the LINQ OnePlatform Middleware supporting services such as tuition and fee payment management, identity and role management, student application status management services, among others. Services include:
105a. OEP(Online Education Platform) which can be similar to Canvas in one embodiment.
105b. A payment module that can accept tuition payments from students in countries around world. One possible implementation is using Stripe. Can easily payouts to course instructor (individual) or other institution.
105c. An identity and role management module that can grant course content access for authorized users. Secure student privacy. Manage user accessibility based on their role.
105d. An application status management module that can track enrollment status, provide better support during student application.
105e. An end to end course registration process: from application submission, email registration and tuition payment to course access distribution, learning experience tracking and user feedback and support on tech and academy and finally certification delivery to hands.
105f. LINQ 3rd party API: Provide learning plan and learning pace tracking, application review, feedback support services. The API also provides an admin portal for 3rd party organization (view, organize and contact their users).
105g. A tree like structure of 3rd party organization for student management and support (with parent/child departments/agents).

The middleware 105 communicates with databases 106 that in turn communicates with an analytical data warehouse 107. A secured Operational Data store is provided between user data (payment info, course progress, registration/application info and so on) and also course content invented/developed by course instructor/designer. The analytical data warehouse 107 in turn communicates with a Data Warehouse 110 that stores scheduled data sync and backup, data analysis. A data cache 108 provides durability and high performance data storage for the middle services 105. OSS 9 is an object storage service providing encrypted and secure file uploading. The Data Warehouse 107 stores Analytic Data that are used by data visualization services 112 for data analysts. In one embodiment the visualization services run Tableau. Large scale learning machines or computers 111 are provided to process data in data warehouse, tuning our platform to be more user friendly and personalized.

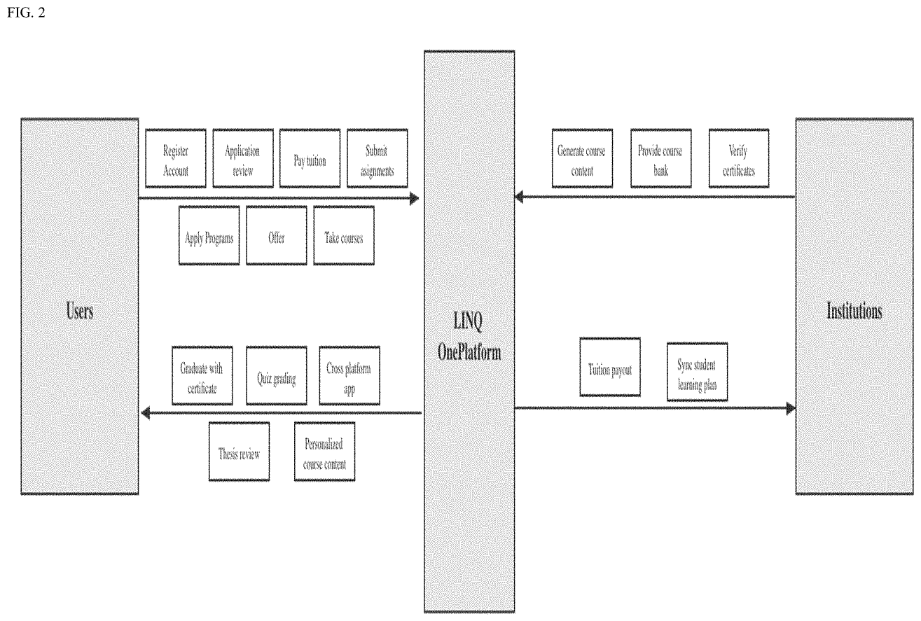

FIG. 2 shows an exemplary flow of the system of FIG. 1 connecting students/users with institutions. Users can perform actions such as account registration, application review, pay tuition, submit assignments, apply for programs, review class offers and take courses, among others. The platform in turn can provide the students with results such as graduation certificates, quiz grading, thesis review and personalized course contents. Cross platform educational apps can also be supplied. The platform in turn can communicate with one or more institutions by sending information such as tuition payouts and student learning plans, for example. The institutions in turn can generate course contents, provide course banks of study materials for students to take, and verify certificates, among others.

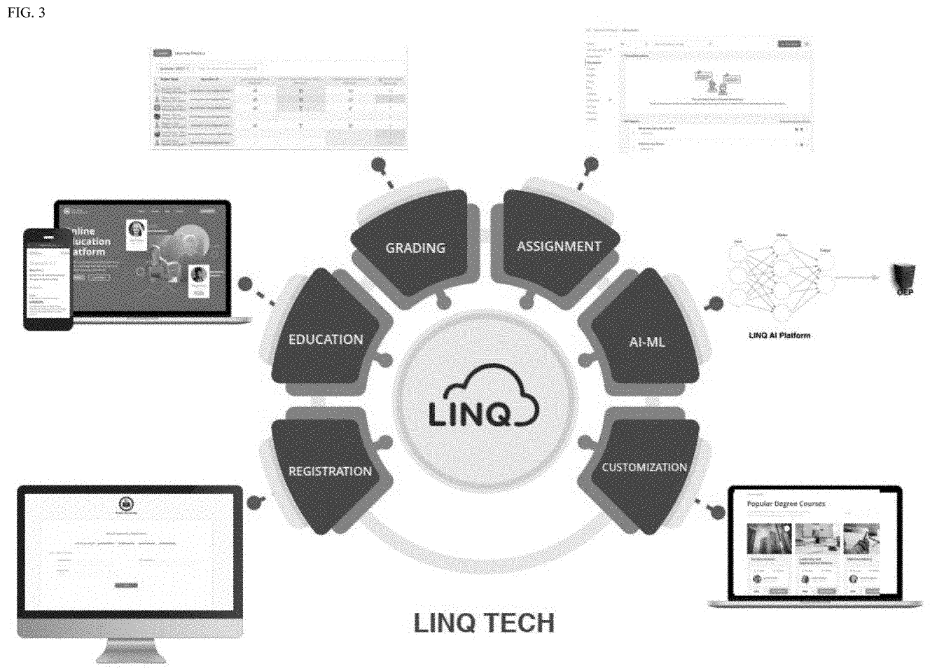

FIG. 3 shows an exemplary flow of student services provided by the LINQ system. Students can connect to the system using mobile devices, desktop computers or suitable browsers. The student can perform class registration using the system. The University Student Registration Systems is a simple to use and install application that allows for the creation of an online registration portal for universities and colleges. The system includes several database systems and application development features. The system allows for the deployment of various enterprise application platforms such as ERP, CRM, and a number of other business solutions. This system is designed to help facilitate efficient, consistent data and transaction processing for a wide range of business needs.

The student can also take on-line courses using the system and can view videos of the classes and communicate by chats if desired. The system is compatible with a variety of browsers and can be used with a wide range of operating systems. The system can facilitate efficient and secure electronic payments for students as well as the institutions they are attending.

The system receives assignments uploaded by students for review by the teacher/TA. After students have completed writing reports and check for errors, they can upload their assignments to the portal.

Tests and quizzes are graded by the teachers or assistants, and results can be communicated online. Assignments can be submitted using the system. Students often receive a grade report as part of the academic process. Most schools and colleges require that you grade your assignment according to an assigned standard, such as the average grade point average (AGPA) or a certain percentage of the total points assigned. There are also some schools and colleges which only grade on the basis of written essays or tests. The system provides instant assurance when each assignment is submitted, and ensures that the assignment has already been graded by a person or committee. The student can send a request to the professor for one who will grade your assignment according to the assigned standard. Professors may give out assignments with assigned standards. They also assign students to either get a grade for an assignment or a group assignment.

Machine learning assistance is provided to help optimize the student learning experience, as described in depth below. Additionally, customization of the system to the user can be done.

Online uploading of application materials can be replied within 24 hours at the soonest. Registration procedures for online classes are simple and the online system learning interface is intelligent.

Online Study is aided with full-time teacher coaching service, online classroom project group, online assignment submission, midterm project, online final exam.

After completing the online education course and issuing the graduation certificate and degree certificate, graduates can choose to attend the graduation ceremony.

In addition to conventional diplomas, the system can generate adult and executive online professional certification training in various fields such as artificial intelligence, finance, science and technology, blockchain, among others. The certification can cover vocational skills training, government certified vocational skills certification. Teenagers online professional certification training can also be included in the courses offered by the system.

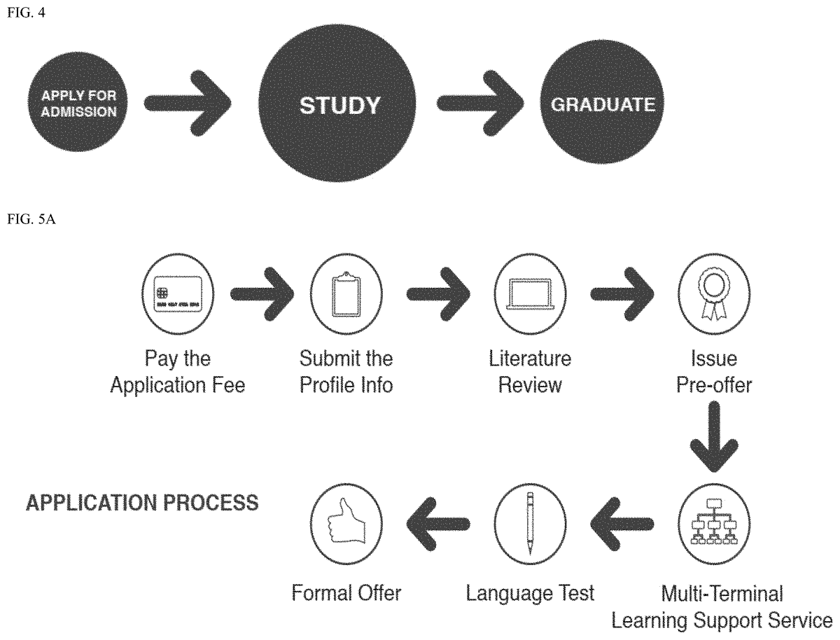

FIG. 4 shows an exemplary process for educating students. Similar to the conventional process, students apply for admission to the school. Once accepted, a study plan is set up to satisfy graduation criteria. Upon satisfaction of degree requirements, the student graduate with a degree. Degree from an accredited institution may allow a student to start at a higher position. Most employers prefer people who are employed with a bachelor's degree or higher and a diploma from an accredited institution. Graduation typically takes two to four years depending on which school/institution the student attends. Employers want to know how many years of experience the student has, but it also helps to know the total amount of time it will take to finish his/her degree. Some schools may offer accelerated degrees, meaning that the student can finish his/her degree sooner than the normal two or four-year period. This type of program can help the student get ahead faster in his or her career. The instant system can help the student to graduate faster than the standard time if the student can show or prove that he/she has satisfactory mastery of a portion of the degree requirements and thus only needs to take supplementary courses to complete the degree requirements.

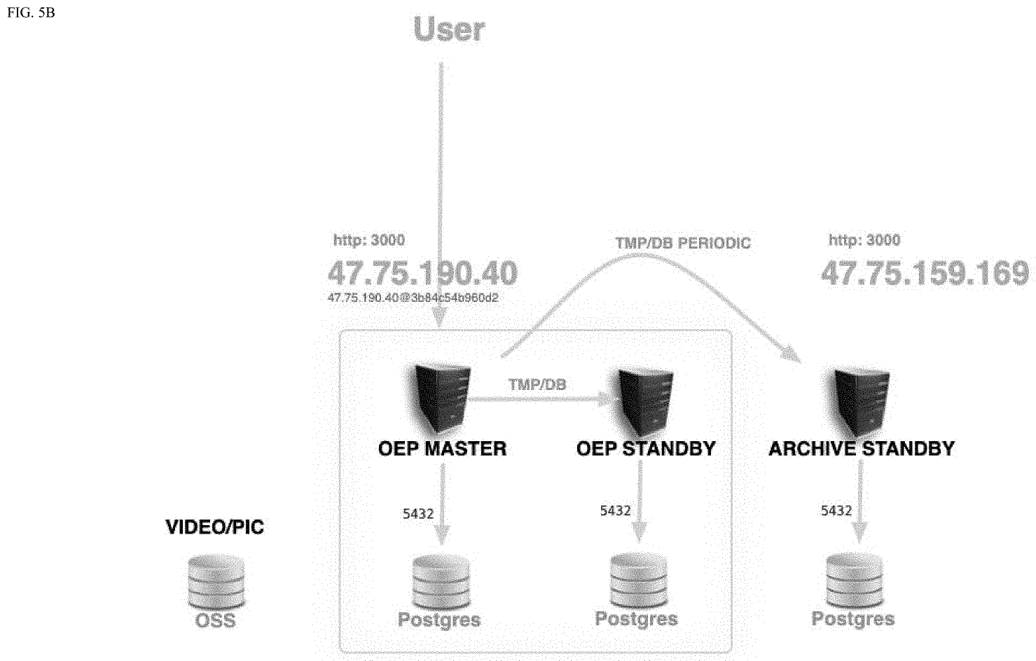

FIG. 5A shows in more details an exemplary application process for applicants who are not native English speakers. Applicants pay an application fee and submit his/her application profile. The applicant will have to submit the appropriate forms to the school and may need to provide financial information so that the school/institution can calculate your fees and costs. Some schools require that you submit letters of recommendation from former professors or supervisors, while others may ask that you submit letters from your current employer. FIG. 5B shows an exemplary architecture for deployment and infrastructure. As show therein, users access a master OEP server that communicates with a database such as a Postgres DB. The master server communicates with an OEP standby server as well as an archive standby server and their respective Postgres DBs. The video is served from a separate server.

A review is conducted of the applicant's suitability in light of competing applicants for entry to the school. If the student meets predetermined quality criteria, the system issues a pre-offer and a language test is conducted through a learning support service. If the student passes the language test, a formal offer of acceptance is sent to the applicant. If the applicant accepts and registers, he/she can enroll in classes and graduate upon meeting all graduation requirements. The final step in the process is to receive the degree from an accredited school.

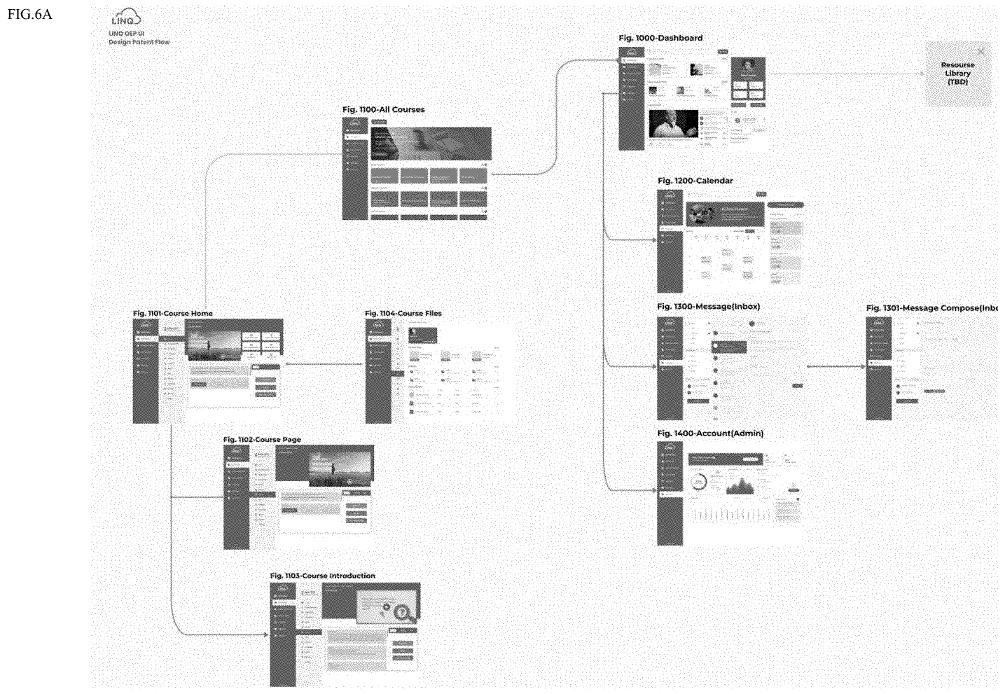

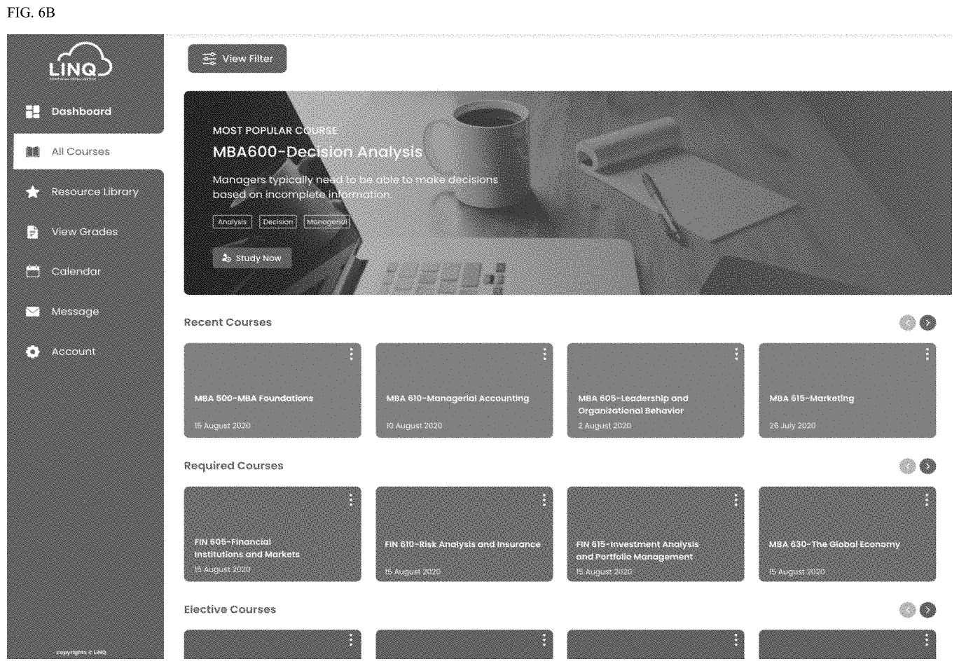

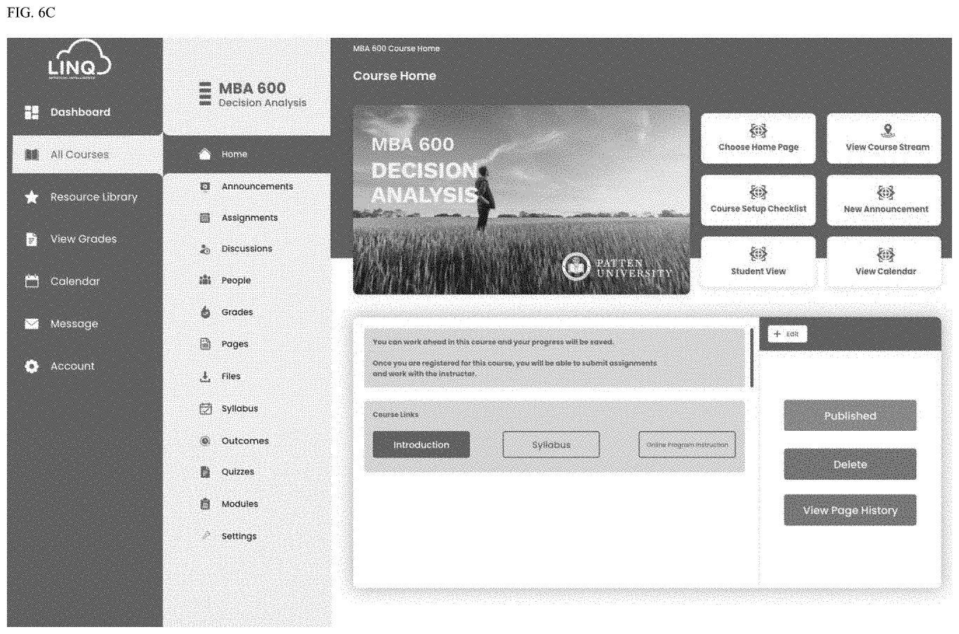

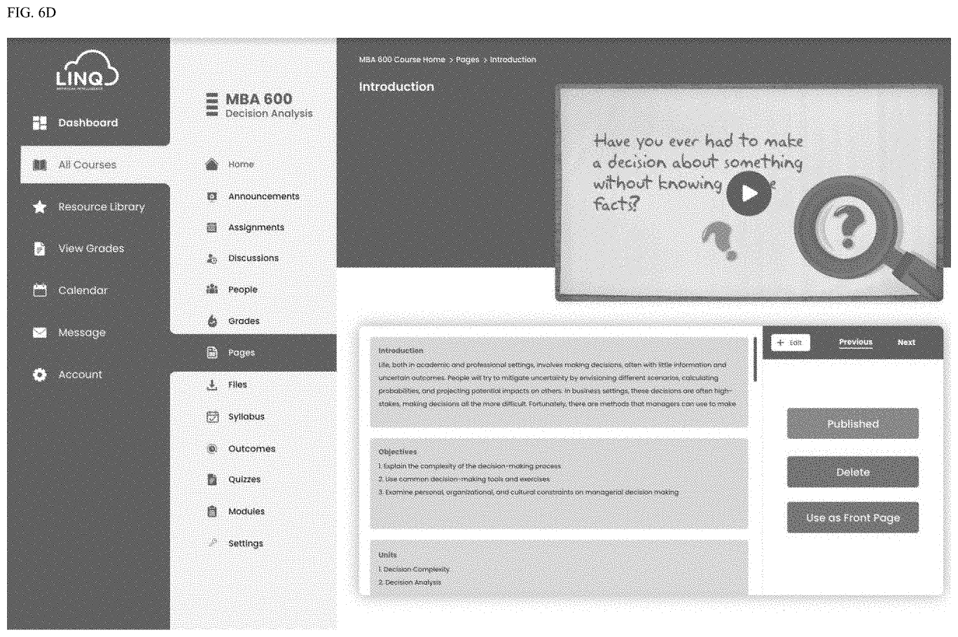

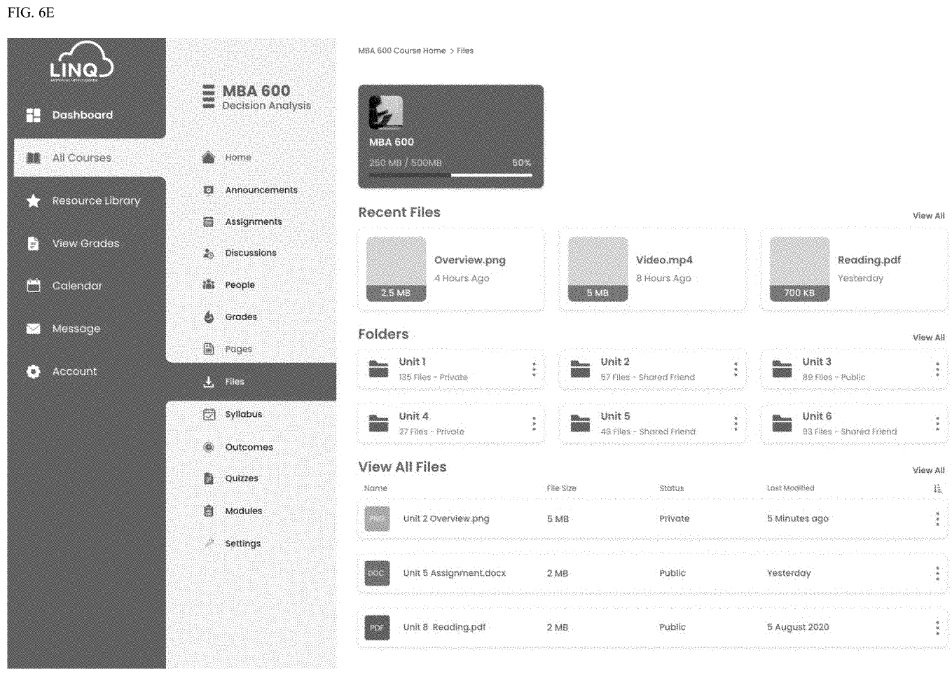

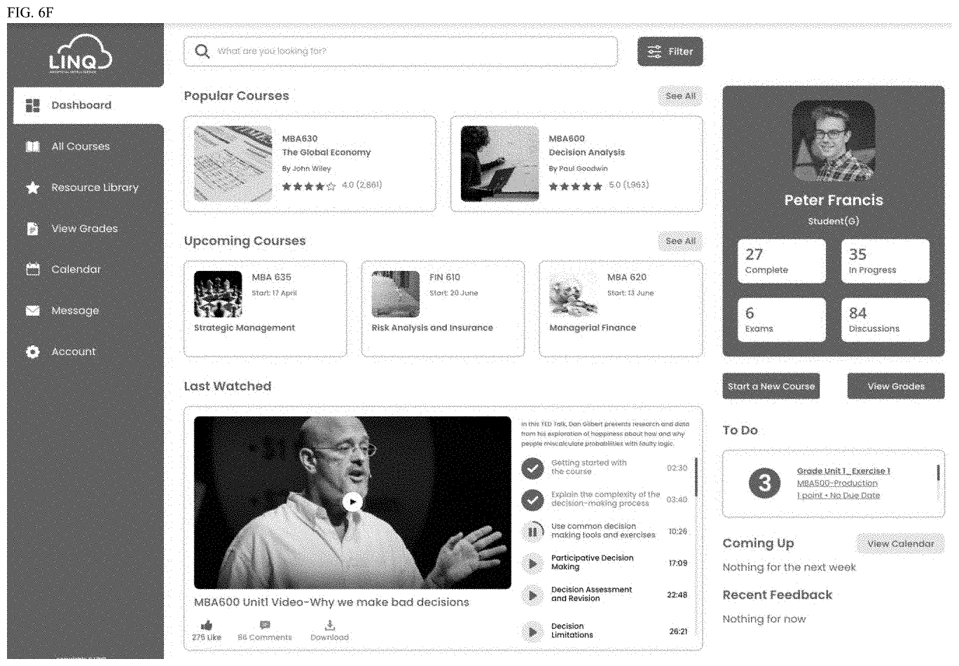

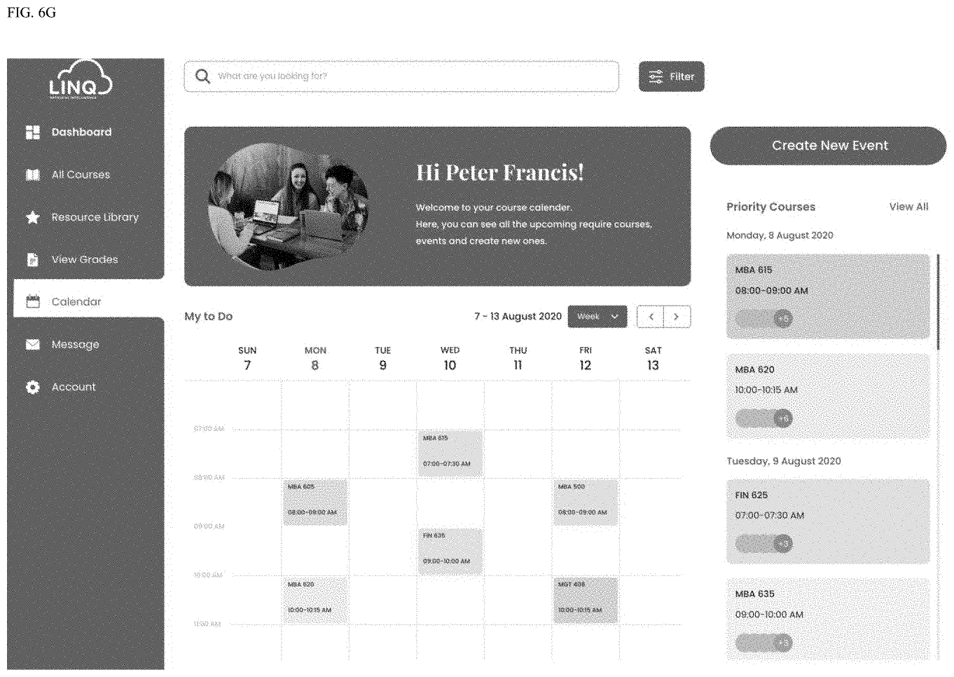

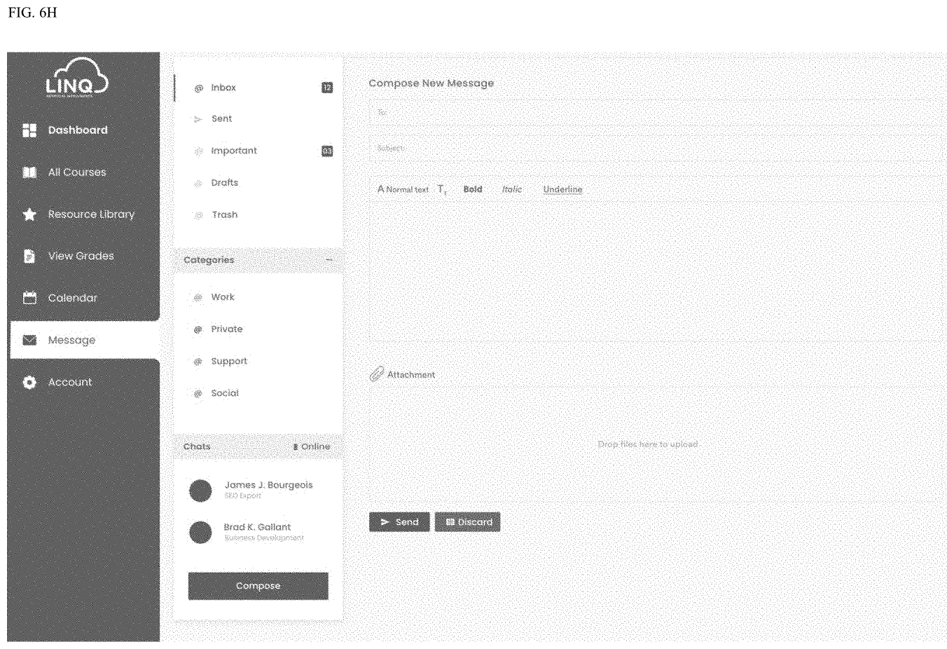

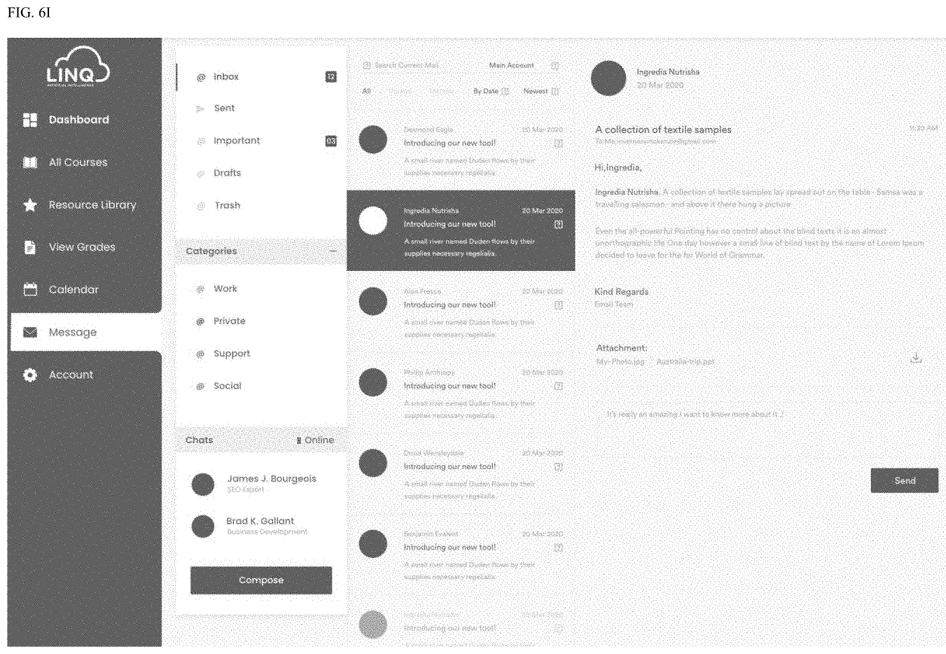

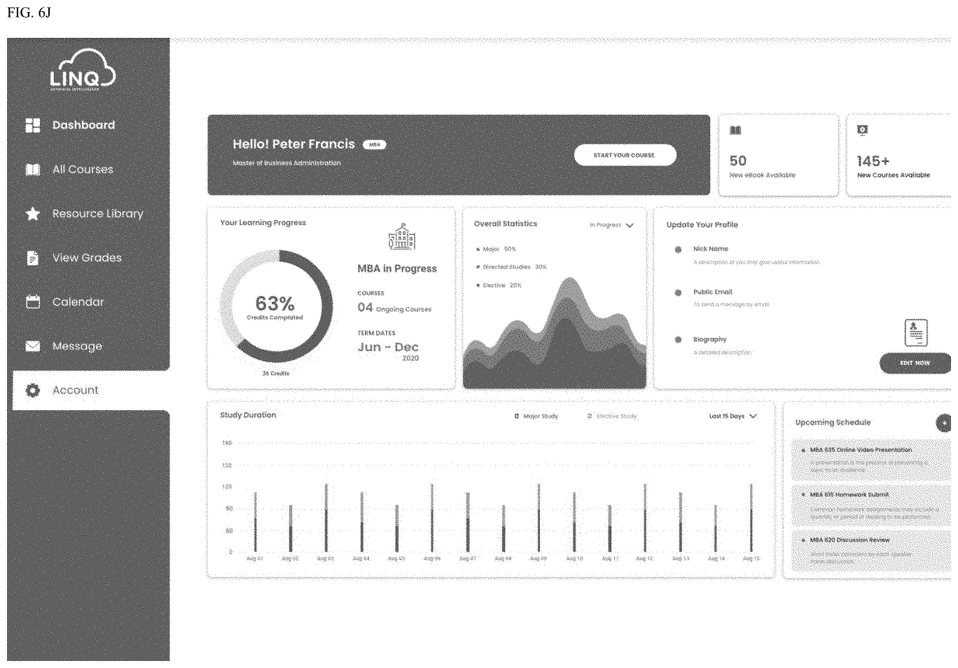

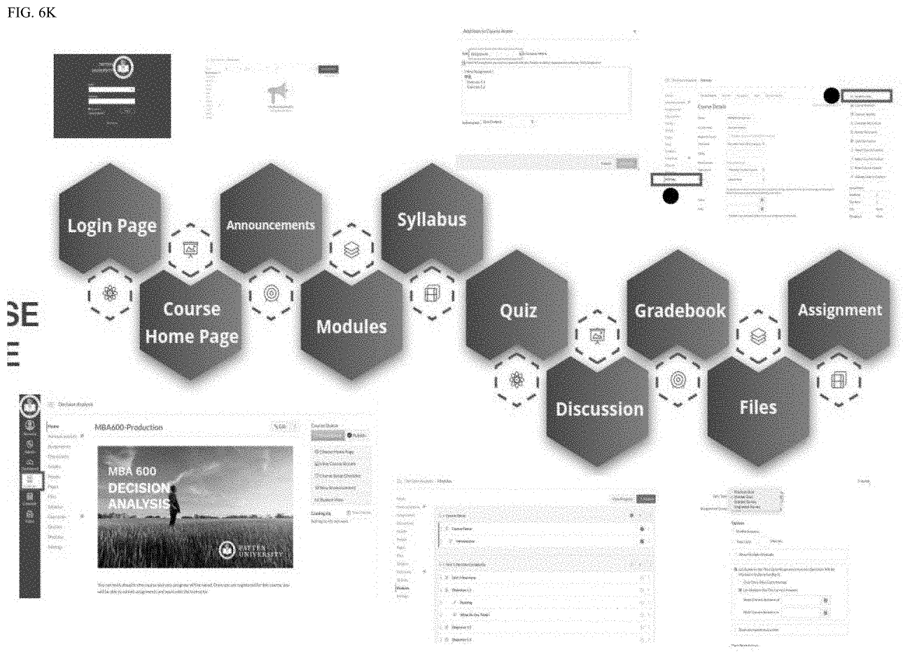

FIG. 6A-6K shows exemplary student user interface designs for the LINQ OnePlatform. FIG. 6A shows an overview of the exemplary student usage flow in the LINQ OnePlatform. FIGS. 6B-6K show in more detail various user interfaces for login, course home page, announcement, course modules, syllabus, quiz, discussion, gradebook, assignments, and associated stored files.

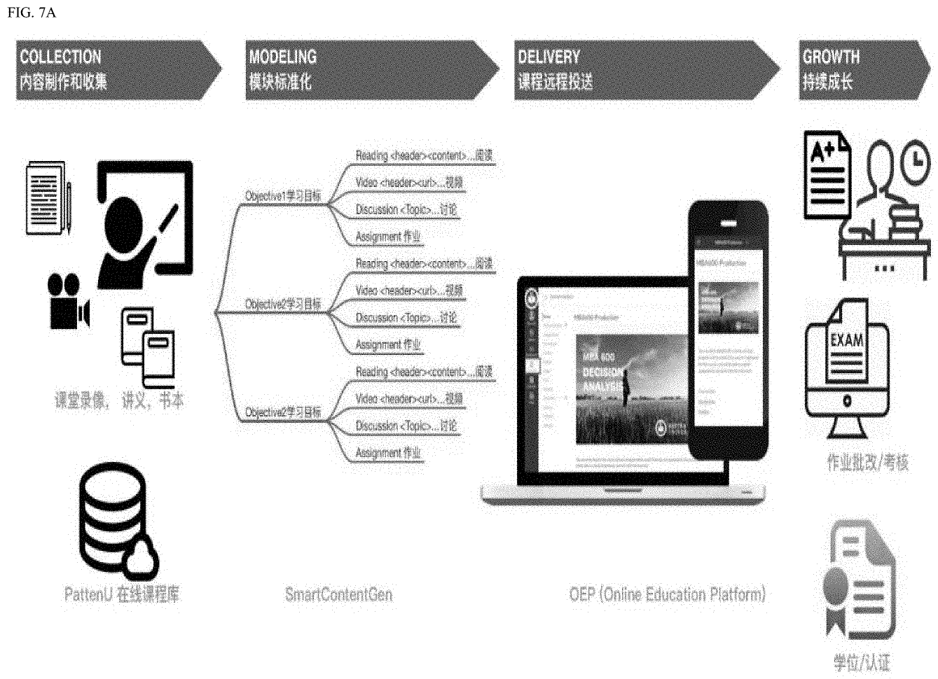

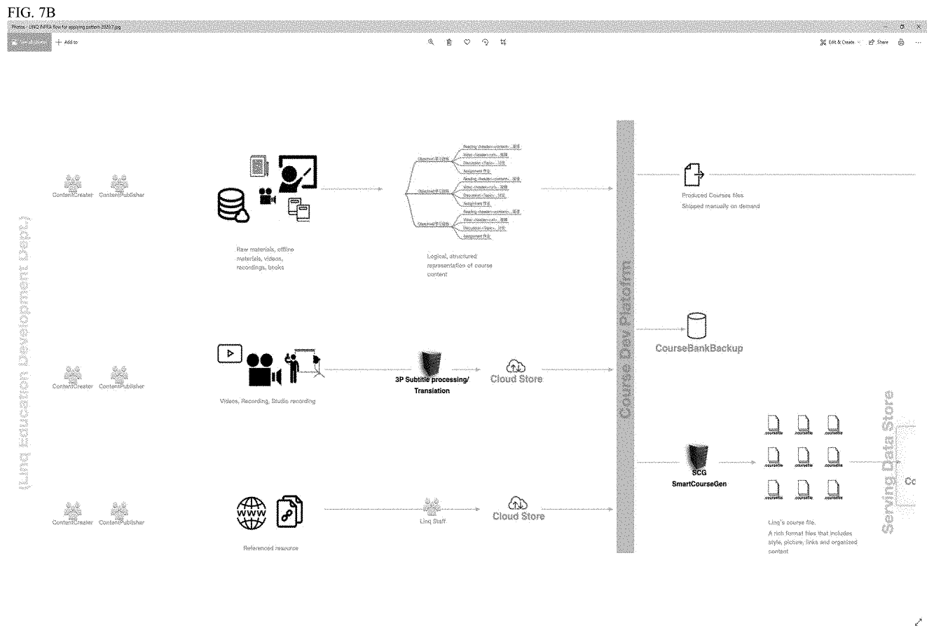

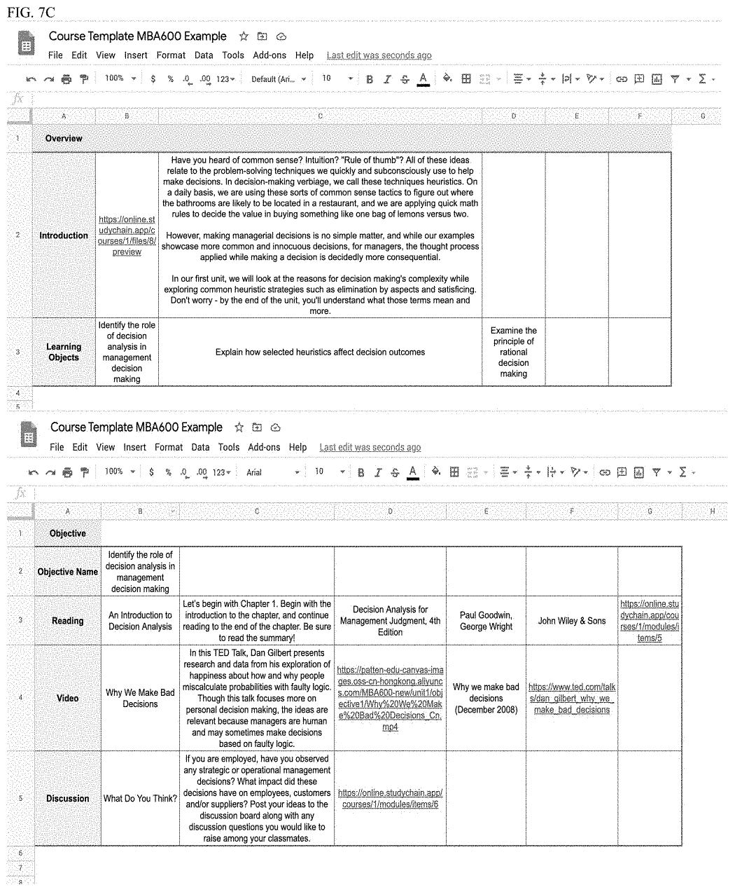

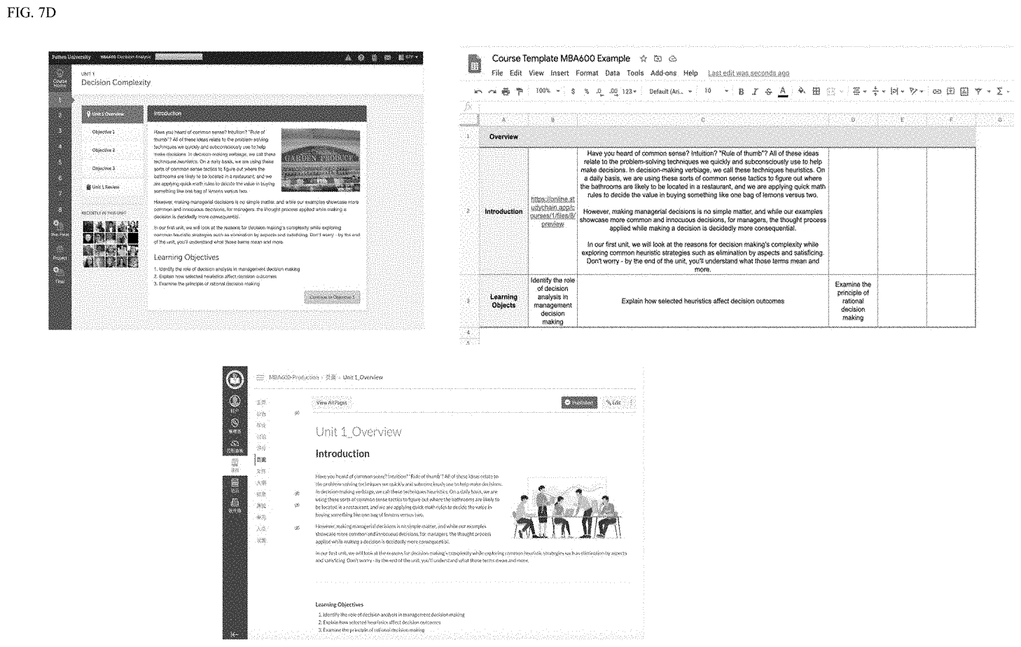

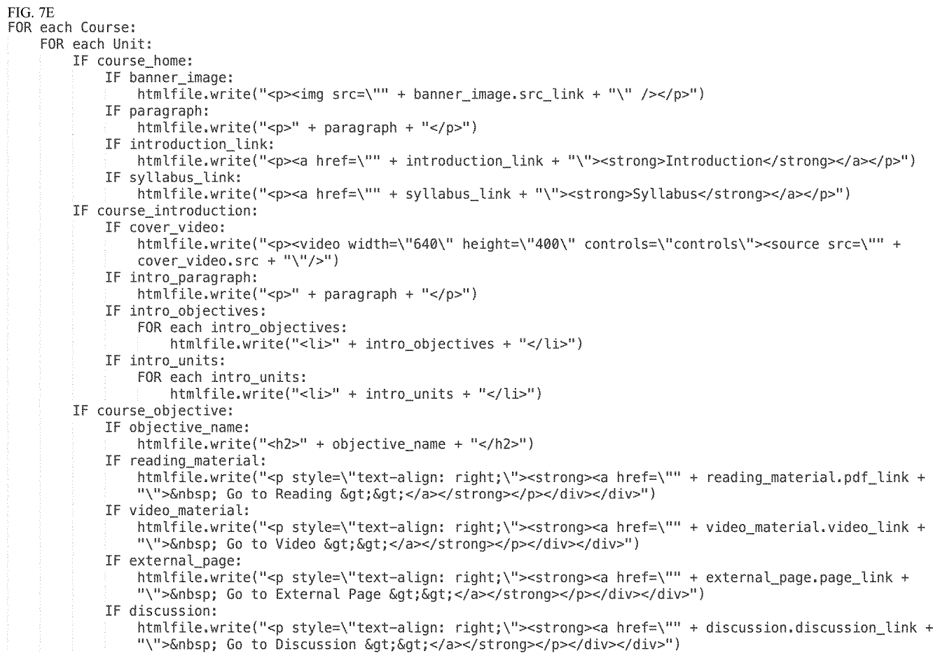

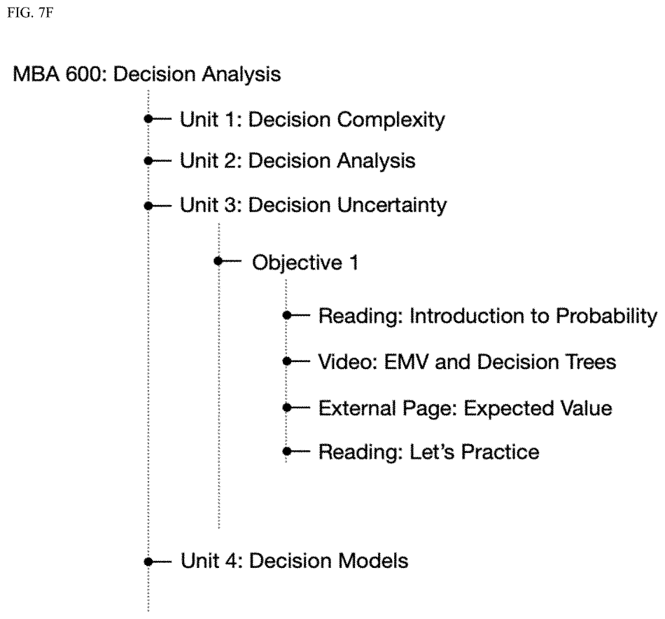

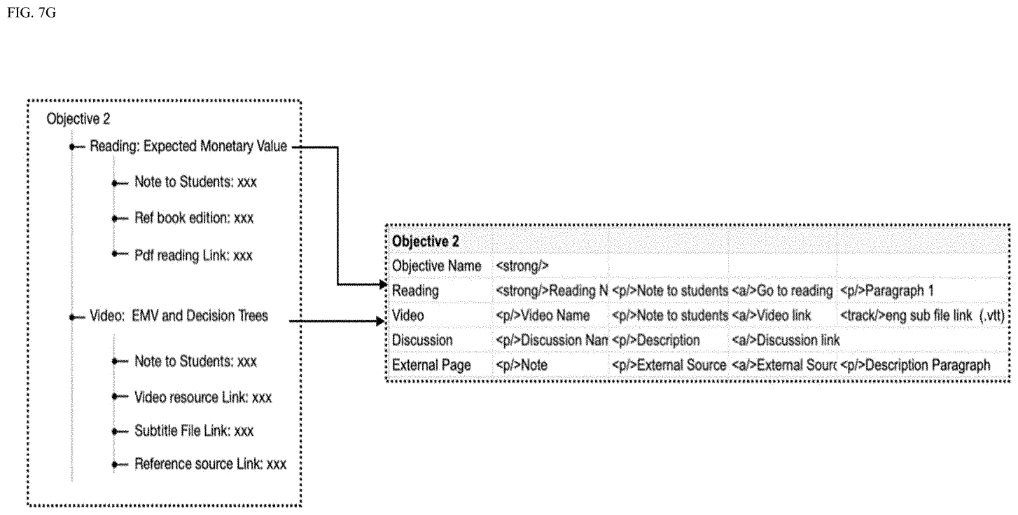

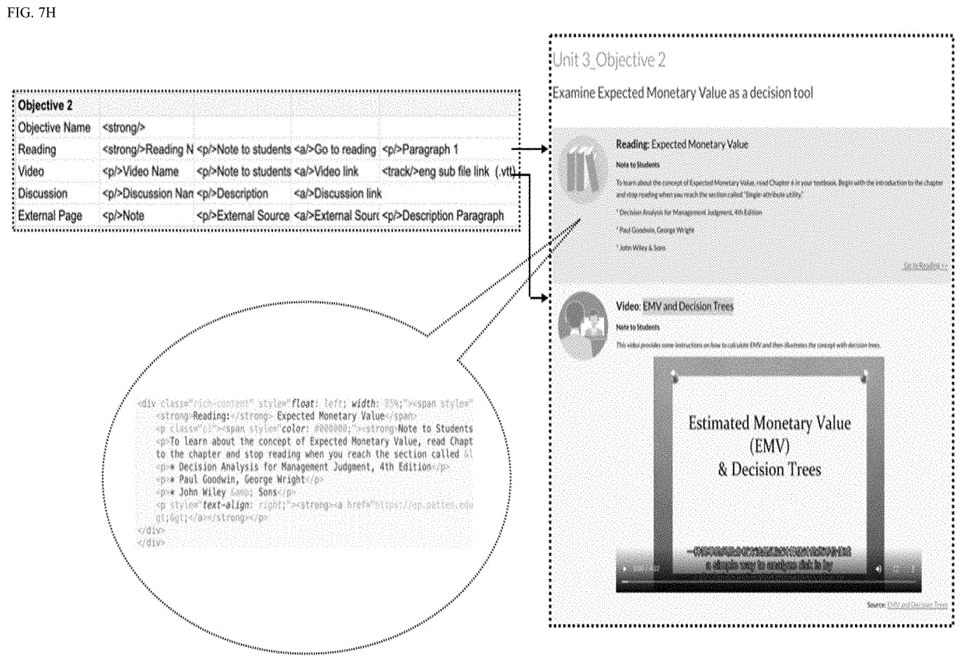

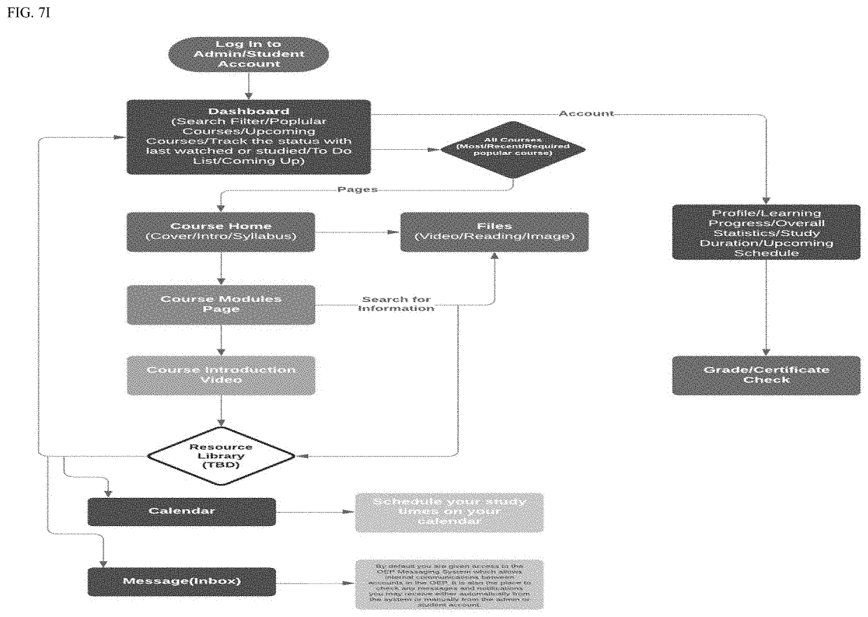

FIGS. 7A-7I show an exemplary process for generating educational materials and their use with to achieve personal growth objectives. FIG. 7C-7D show exemplary spreadsheets documenting the course content. The spreadsheets are used in the method of FIG. 7E as follows:

```
FOR each Course:
  FOR each Unit:
    IF course_home:
      IF banner_image:
        htmlfile.write(“<p><img src=\“” + banner_image.src_link + “\” /></p>”)
      IF paragraph:
        htmlfile.write(“<p>” + paragraph + “</p>”)
      IF introduction_link:
        htmlfile.write(“<p><a href=\“” + introduction_link + “\”><strong>Introduction</strong></a></p>”)
      IF syllabus_link:
        htmlfile.write(“<p><a href=\“” + syllabus_link + “\”><strong>Syllabus</strong></a></p>”)
    IF course_introduction:
      IF cover_video:
        htmlfile.write(“<p><video width=\“640\” height=\“400\” controls=\“controls\”><source src=\“” +
        cover_video.src + “\”/>”)
      IF intro_paragraph:
        htmlfile.write(“<p>” paragraph + “</p>”)
      IF intro_objectives:
        FOR each intro_objectives:
          htmlfile.write(“<li>” + intro_objectives + “</li>”)
      If intro_units:
        FOR each intro_units:
          htmlfile.write(“<li>” + intro_units + “</li>”)
    IF course_objective:
      IF objective_name:
        htmlfile.write(“<h2>” + objective_name + “</h2>”)
      IF reading_material:
        htmlfile.write(“<p style=\”text-align: right;\“><strong><a href=\”“ + reading_material.pdf_link +
        “\”>&nbsp; Go to Reading &gt;&gt;</a></strong></p></div></div>”)
      IF video_material:
        htmlfile.write(“<p style=\”text-align: right;\“><strong><a href=\”“ + video_material.video_link +
        “\”>&nbsp; Go to Video &gt;&gt;</a></strong></p></div></div>”)
      IF external_pagae:
        htmlfile.write(“<p style=\”text-align: right;\“><strong><a href=\”“ + external_page.page_link +
        “\”>&nbsp; Go to External Page &gt;&gt;</a></strong></p></div></div>”)
      IF discussion:
        htmlfile.write(“<p style=\”text-align: right;\“><strong><a href=\”“ + discussion.discussion_link +
        “\”>&nbsp; Go to Discussion &gt;&gt;</a></strong></p></div></div>”)
```

Viewing collectively FIGS. 7A-7H, an exemplary process for educating students using the system of FIG. 1 is detailed. First, teaching materials are collected and prepared for teaching the students. As detailed in FIG. 7B, teaching content creators can create videos, illustrations, and other interactive or static content to be used by students for learning. Video contents can be transcribed and translated for international students. Text materials can be bound into books or sold as restricted contents or locked PDFs for use by students upon purchase from a store, for example. These materials are prepared by the teacher for the student at the time of teaching. The teacher may ask for the opinion of previous students before he or she starts the lesson so that he/she can do something to improve the lesson. Material used in teaching lessons are checked to keep them clear and well presented. The students should learn every lesson easily and without any problem. In addition to that, the material used in teaching should be well researched. The teacher has complete knowledge about the subject before he/she starts teaching any lesson. Students should always try to understand the lesson in order to make an informed decision about the lesson. The materials can be commented by students who have failed in the lesson so that he/she can discuss with the teacher about the mistakes that were made in the lesson.

Next, one exemplary process to generate teaching materials is detailed.

Step 1 of Course Development Flow is to analyze the market and understand student user needs.

Step 2 is the Course Development Plan. According to the actual needs of users to create a course syllabus and the timeline.

Step 3 is Create Course Content. Create the course content according to the course plan.

Step 4 is to publish the course, to publish our courses to our online study system.

Step 5 is the course evaluation. Based on students' feedback, the teachers can do product iterations.

In details, the process creates the course content as follows:

Step 7, creating the Course Content Template Excel as shown in FIG. 7C-7D. This Template Excel contains four parts: Step 8, Step 9, Step 10, and Step 11. We think any course can be restructured to these four parts for students to learn. The first part is

Step 8, Design visual element (course overview images). Students can see the course name directly through the picture.

The second part is Step 9, create reading materials. This section is composed of text and mainly contains the content that students need to read.

The third part is Step 10, Create video Materials. The system converts the content into video materials with subtitles. Students can learn by watching videos.

The fourth part is Step 11, Create External materials. External materials include an External link to connect to External materials, and students click on the link to view their study materials.

Step 12, the teachers upload all materials to the server and generate the URLs. These URLs allow the program to identify the material's storage path.

Step 13, the teachers input the URLs to the template excel. The system can generate the code through the Excel spreadsheet.

Next, an exemplary process shows how we publish the course content to our online learning system. Step 15 is the start of this flow.

Step 16, the system opens the course content template excel file previously created

Step 17, the system downloads the CSV file from the excel.

Step 18, an HTML File Generator is used to generate the HTML file.

Step 19, the system imports CSV files to HTML File Generator.

Step 20, the system generates the execution code to run the HTML File Generator. The program begins to execute and output the HTML code file.

Step 21, in online learning system, the system imports the HTML file, and edit the web page.

Step 22, the teacher can edit the rest of the course content, such as the title and page order.

Step 23, the teacher can edit the basic settings, set up the system user interface display.

Next, the learning materials are modeled to achieve class objectives. In one embodiment, a class can have a number of class objectives, each with files for reading, videos, discussions, and assignments. In course objective reading, the student may be required to write an essay on an assigned topic and then read that essay in the context of a video discussion. A discussion board may be used to discuss the assignment and students are encouraged to express their views and opinions on the video in the discussion forum. The teacher can also have an open forum where the students can post their comments or questions. For the class discussion, the teacher may need to provide a resource box that contains information about the course, and where the student can go for further information.

With course objective reading, students can learn how to create discussion boards in order to facilitate the course. Other teachers or students can add references or resources available to help with the course objectives.

The course materials are then finalized for use by students. In addition to providing students with enough information to learn, course instruction materials should also be easy for students to use and understand. Students should be able to learn by using this material and not need someone to read the information for them. Some instructors even provide software that can assist students in learning because most courses do not cover every aspect of the subject matter.

Next, the course instruction materials are delivered. Course instruction materials are delivered in a way that makes it easy for students to understand and to use them effectively. Delivery can be done over the internet or through physical media. The materials can be text, PDF, images, videos, or programs. The content can be saved as electronic files on hard drives or CD-ROM containing instructions on the use of classroom software. For students to learn as quickly as possible, they must also be able to access the content at any time throughout the semester. The type of instructional material that is used for teaching is not necessarily dictated by a particular course or subject matter that needs to be taught. The information contains a sufficient amount of information to allow students to successfully complete their studies. Some courses, such as chemistry, require a greater amount of information than others, such as biology or English composition. When instructional material is delivered in a manner that makes it easy for students to comprehend what is being discussed, it is more likely that they will have a greater understanding of the material at hand. This will help them feel more confident in their ability to complete the material and take it all on successfully.

By studying, the student experiences personal and professional growth. Grades and the diploma enable the students to show employers that they are committed to pursuing self-improvement by getting a diploma from a recognized school or university. This type of diploma can also serve as a reminder of their dedication towards their education.

For students who are unable to attend school full time, there are other options for them to complete the requirements for their diploma. Getting great grades and the diploma afford students the chance to show that they are able to handle personal responsibilities such as responsibility and self-discipline. The level of responsibility that they will need to handle at home requires that they have worked hard in the classroom but in the process will earn a diploma which demonstrates their commitment to a successful lifestyle.

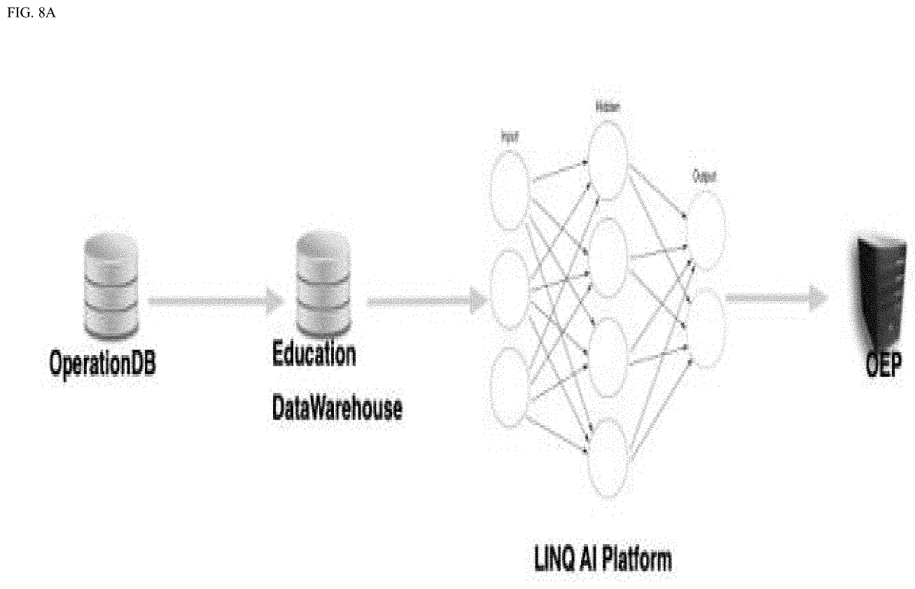

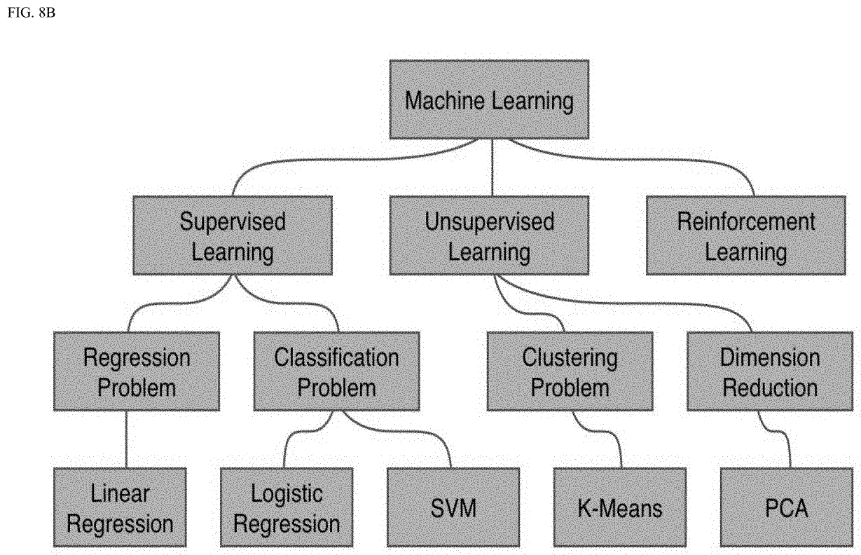

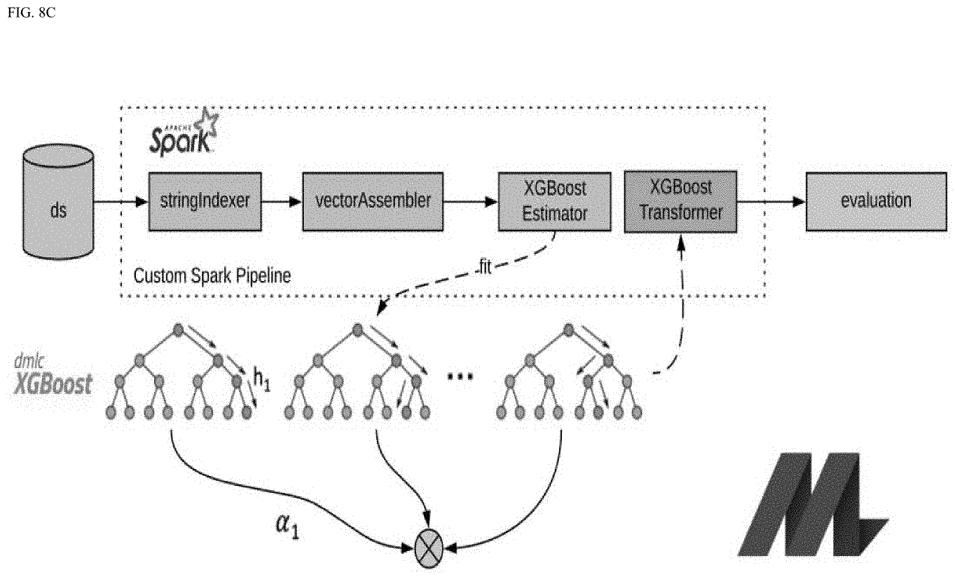

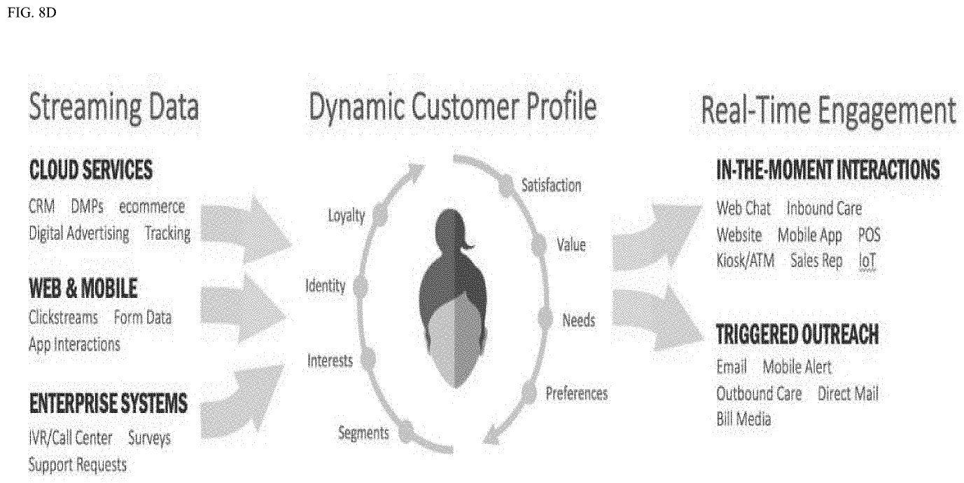

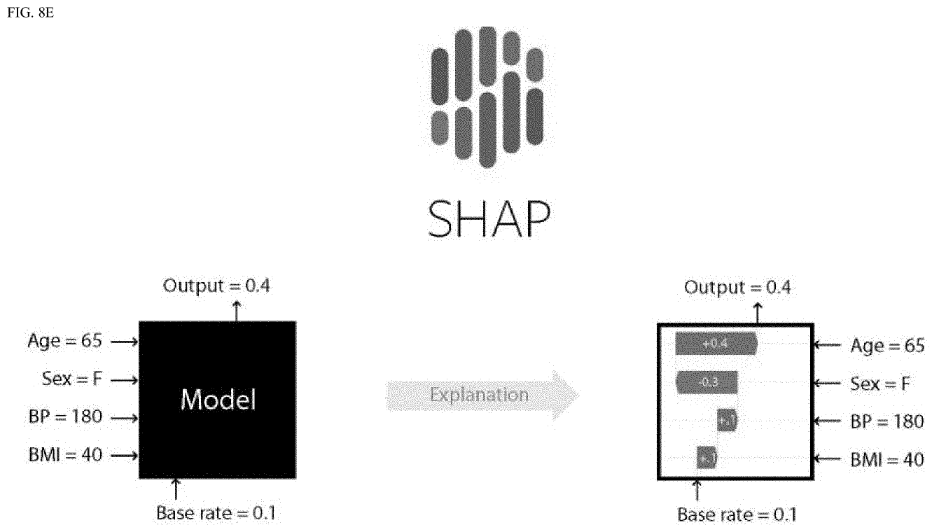

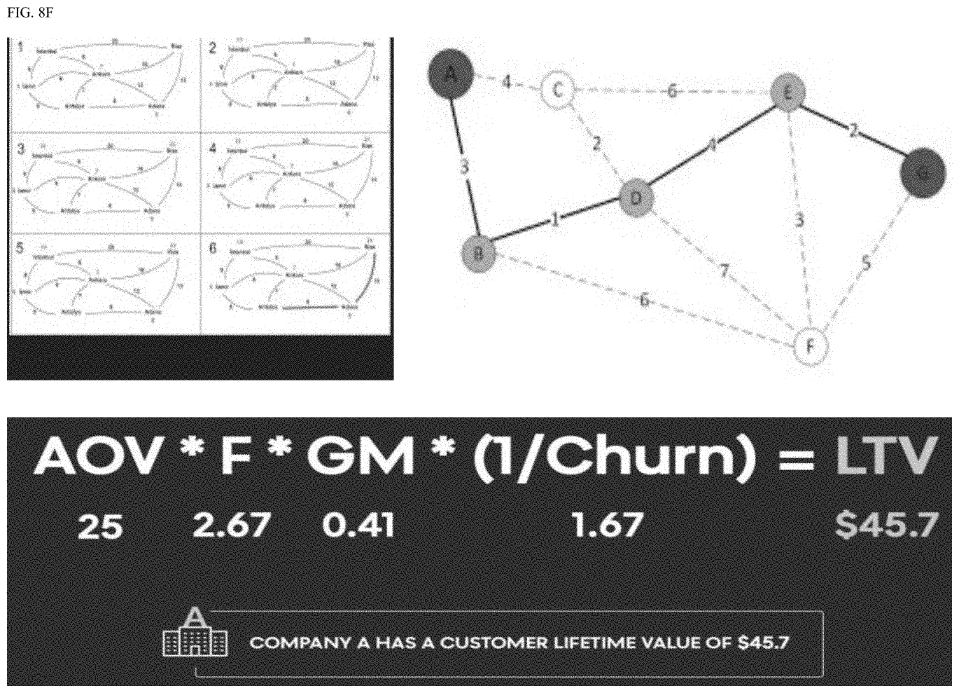

FIGS. 8A-8B show an exemplary AI enabled educational platform. The platform includes an operation database communicating with an education data warehouse containing student learning and behavioral data. The data is then provided to an artificial intelligence (AI) platform that communicates with the online education platform (OEP). The OEP online education system is a data-driven artificial intelligence online application learning platform that solves two basic problems in the education industry: what to teach and how to teach. Individuation is the inevitable trend of education development. The online system uses big data and artificial intelligence to help teachers achieve personalized teaching rhythm, accurate teaching materials and artificial intelligence scores. Students can choose the corresponding learning modules and courses according to their own conditions, so as to realize personalized learning.

FIGS. 8C-8F show exemplary AI-based student profilers. Usage data captured by the system is used for training an ANN model to predict a student's life time value (LTV) for every new onboarding student. System will also predict for this student, what are the likelihood that s/he will drop out at each critical enrollment/study process. Given these two information, systems will recommend the appropriate incentive during each of these critical procedures and try to prevent student from dropping out. For a student to complete a program, multiple courses need to be finished. Courses also blocking other courses as prerequisite. A certain student to take a course with certain background has a quantifiable likyhood to succeed or fail. Given this, the system models a student to finish a course as graph path finding problem. A system will build a graph, predict the student's chance to be able to finish the next course and give a suggestion of which next course to take. In the embodiments shown in FIGS. 8C-8E, a directed acyclic graph (DAG) is used to optimize the LTV determination.

LINQ OEP provides high-quality general education courses for the first two years of undergraduate study (online/offline, recognized by 100 top universities in the United States), which can be developed into a big data platform for general education in the United States and an entrance for the flow of basic education in universities. Improve the online education system, provide teaching resources covering 90% of higher education textbooks, add interactive live broadcast and conference system, and enhance the function of personalized teaching module for students.

The system can be used to cooperate with global educational institutions to customize higher education courses, export online education platforms and teaching resources, and establish a teaching network platform covering the whole world. AI is integrated into platform education, promote the integrated development of big data, intelligent education and educational Internet of Things, and build a integrated intelligent teaching, management and service. The use of big data and AI technologies helps instructors achieve personalized learning pace, precise teaching material, and AI grading. includes four major components: Operation Database, Education DataWareHouse, LINQ AI Platform and OEP Platform.

It will be further appreciated by those of skill in the art that the online education system and method of the present invention offers the advantages of “distance learning”, as is well known in the art. In addition, however, the present invention, by use of the audio and/or video controlling mechanism of the present invention, the system provides a means by which the student is required to “attend” the lesson for a specified period of time. In particular, the student must “attend” the class for a time at least equal to the time required to play the audio file(s) and/or video file(s) associated with the lesson. Further, the ability of the educator provider system to generate a lesson completion record and transmit the same to the student system and/or to the education authority system, provides immediate feedback and acknowledgement to the student and/or education authority. Such acknowledgement may be critical if the student completes the lesson at a time near the deadline imposed by the education authority or regulating authority.

In addition to the audio and video controlling and lesson completion features, the present invention also provides a vehicle by which the student can interrupt, or leave, a lesson, and return to the point of interruption in the future. This feature is accomplished by storing the interruption point at the educator provider system. Further, the educator provider system keeps track of the answers made to any tests given during the lesson. Not only are the test results necessary to ensure “successful” completion (if testing is required by the education authority), but the test results can also be analyzed to ascertain whether the student is paying attention to the lesson or merely making guesses. If the student is only making guesses, the student and/or education authority can be so notified and/or the student can be considered to have failed the lesson.

It will also be appreciated that, while the example of a course for a childcare provider or preschool educator is presented herein, the method and system of the present invention is not limited to such an application. The method and system of the present invention can be utilized for education of any type from any type of educational institutional. In addition to the other examples already discussed herein, the method and system of the present invention may be used by a company to train its employees or any subject, by a manufacturer to train its sales representatives, or by an automobile manufacturer to train dealers' service persons, for example.

The system and method of the present invention provides the educator with confidence in the integrity of the online lesson. Time requirements is guaranteed and satisfactory completion in all respects are measured by the present invention. Thus, by use of the system and method of the present invention, the educator need not be limited to no-credit or audit classes in an online environment. Instead, an educator can make available all of its initial (pre-service) and continuing (in-service) courses online to achieve the many benefits associated with distance learning.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

Many of the methods are described in their most basic form, but processes can be added to or deleted from any of the methods and information can be added or subtracted from any of the above description without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

What is claimed is:

1. A method to manage students from application to graduation, comprising:
receiving courseware from a plurality of educational institutions, wherein the courseware includes one or more videos generated by an instructor, further comprising translating and captioning the video for global student use;
receiving student work experience and educational history and crediting the student with predetermined credits toward a graduation requirement from a selected institution;
determining courses need for graduation and learning from online course materials as specified by the selected institution; and
upon completion of the graduation requirement, storing a digital diploma from the selected institution for student use as proof of graduation.

2. The method of claim 1, comprising relaying communications from students and the plurality of institutions through an online education platform (OEP).

3. The method of claim 1, comprising supporting services including tuition and fee payment management, identity and role management, student application status management services.

4. The method of claim 1, comprising accepting tuition payments from students in countries around world.

5. The method of claim 1, comprising performing identity and role management and granting course content access for authorized users.

6. The method of claim 1, comprising application status management module that can track enrollment status, provide better support during student application

7. The method of claim 1, comprising providing an end to end course registration process: from application submission, email registration and tuition payment to course access distribution, learning experience tracking and user feedback and support on tech and academy and finally certification delivery to the student.

8. The method of claim 1, comprising generating a learning plan and tracking learning pace.

9. The method of claim 1, comprising receiving an application and providing an on-line admission review, feedback support.

10. The method of claim 1, comprising forming a tree structure representation of a third party organization for student management and support.

11. The method of claim 10, wherein the third-party organization comprises one of: parent/child departments/agent.

12. A system, comprising:
a load balancing reverse proxy server adapted to receive requests from a plurality of student clients and institution clients;
a platform coupled to the server, the platform comprising supporting services including tuition and fee payment management, identity and role management, student application status management services;
an analytical data warehouse and databases coupled to the platform;
a data warehouse coupled to the analytical data warehouse; and
a machine learning network coupled to the data warehouse to generate educational recommendations to help students learn.

13. The system of claim 12, comprising a secure operational data store to store encrypted student data.

14. The system of claim 12, comprising a module to back up the warehouse.

15. The system of claim 12, comprising a visualization module to respond to data analysts.

16. The system of claim 12, comprising code to manage students from application to graduation including code for:
receiving courseware from a plurality of educational institutions, wherein the courseware includes one or more videos generated by an instructor, further comprising translating and captioning the video for global student use;
receiving student work experience and educational history and crediting the student with predetermined credits toward a graduation requirement from a selected institution;
determining courses need for graduation and learning from online course materials as specified by the selected institution; and
upon completion of the graduation requirement, storing a digital diploma from the selected institution for student use as proof of graduation.

17. The system of claim 12, comprising code to manage student services including account registration, application review, pay tuition, submit assignments, apply for programs, review class offers and take courses.

18. The system of claim 12, comprising code to manage educational institutional services including tuition payouts and student learning plans, generating course contents, providing course banks of study materials for students to take, and verifying certificates.

19. The system of claim 12, comprising code for generating a learning plan and tracking learning pace.

20. The system of claim 12, comprising code to process graduation certificates, quiz grading, thesis review and personalized course contents.
